(19) United States
(12) Patent Application Publication
(10) Pub. No.: US 2008/0024806 A1
(43) Pub. Date: Jan. 31, 2008

(54) IN-PROCESS FONT ACTIVATION

(75) Inventors: Mike Bacus, Tigard, OR (US); Elden Wood, Vancouver, WA (US); Clint Daeuble, Portland, OR (US)

Correspondence Address: BANNER & WITCOFF, LTD., 1100 13th STREET, N.W., SUITE 1200, WASHINGTON, DC, 20005-4051, US

(73) Assignee: EXTENSIS INC., Portland, OR (US)

(21) Appl. No.: 11/829,152

(22) Filed: Jul. 27, 2007

Related U.S. Application Data
(60) Provisional application No. 60/820,774, filed on Jul. 28, 2006.

(51) Int. Cl. G06F 3/12

(52) U.S. Cl. 358/1.11

(57) ABSTRACT

Methods, systems and techniques for in-process font activation are described herein. According to various illustrative aspects, fonts for a job in process may be activated by a plug-in or other adaptive or extensible font module. The font module may be configured to conform to an application programming interface (API) of the document creation system in question (e.g., Adobe InDesign, Illustrator, InCopy; Quark XPress, CopyDesk, etc.). A job jacket is maintained that identifies a document for output along with all fonts necessary to create the desired output. During the print process, all identified fonts are activated in-process (i.e., during the print process). When a font is activated, either globally or in the local process space, the font module overwrites the previously activated font in memory in the local process space.

This application claims priority to provisional U.S. Application Ser. No. 60/820,774, filed Jul. 28, 2006, herein incorporated by reference.

### FIELD OF THE INVENTION

The invention relates generally to computer systems and computer fonts. More specifically, the invention provides techniques for in-process font activation to ensure that documents are printed with correct fonts, especially where two different fonts have the same identifier or name.

### BACKGROUND OF THE INVENTION

Most modern operating systems contain application program interfaces for activating fonts globally for all processes, or inside the process space of an application. The current paradigm in font management is to activate fonts globally; the reason for global activation is that activation of fonts locally to a process requires that the activation call be made from within that process space.

Conventional modern document creation systems, like Adobe®, Quark®, etc., have elaborate plug-in interfaces that allow a user to extend the document creation application by having a plug-in launch inside the process space. Frequently, these interfaces communicate valuable information, such as missing fonts in a document, to the plug-in so that corrective action can be taken. A missing font would be, for example, a font that was used to compose the document, but which is not active in computer memory to subsequently render or edit the document.

When conventionally printing a document, a creative professional will create a document and collect for output the fonts necessary to print the document. Alternatively, a creative professional will export the job to a portable document format (PDF) file (or other file format that contains the fonts embedded in the document necessary to reproduce it) for printing. The use of a portable document format (PDF) file is unpalatable to many users, however, since it limits the output on the high resolution side. That is, the document must be converted from its native format into a format that may not necessarily support all of the options in the document creation program. This job, the document and the fonts, are provided to a pre-press company, which activates the fonts and prints the document.

These conventional printing techniques are fraught with problems, however, as there is no unique naming convention for fonts. Generally, the postscript name is used as the main method for identifying and activating fonts at the operating system level. Font foundries often produce fonts with the same Postscript name. Fonts with the exact same postscript names from different foundries often print differently, however. For example, the kerning or some other characteristic of the font spacing for the font used to create a document may be different from a font with the same name actually used to print the document. These differences may cause disastrous results when printing. Text on the pages may reflow, for example, so that the document cannot be accurately reproduced.

As previously noted, conventional font management plug-ins are written to connect to modern document creation systems like Adobe, Quark, etc. As also noted above, the plug-ins are notified if a font is missing, i.e., when the postscript name embedded in the document does not match the postscript names of the fonts in memory. Because these plug-ins do not distinguish between different fonts with the same postscript name, however, an incorrect font can easily be used. Further, the spacing differences may be so slight that it may be difficult for the pre-press operator to detect the errors and correct them prior to printing, resulting in more cost overruns for the creative professional having to send the job back to be done properly.

To address this problem, many pre-press operators have learned over time to deactivate all fonts in memory, and then only reactivate the fonts for the job in question. This approach does not work for systems fonts, however. Most modern operating systems require a certain set of system fonts to function. Removing these fonts from the operating system will cause the operating system to cease to function. Printing a document that uses one of these fonts, such as the Helvetica font on the Mac OS X operating system, for example, thus can be problematic. The pre-press operator would have to override the Helvetica system font by manually activating a Helvetica font that came with the job in order to print the document.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to various illustrative examples of the invention, the fonts for a job in process may be activated by a plug-in or other adaptive or extensible font module. The plug-in may be configured to conform to the application programming interface (API) of the document creation system in question (e.g., Adobe InDesign, Illustrator, InCopy; Quark XPress, CopyDesk, etc.). A job jacket is maintained that identifies a document for output along with all fonts necessary to create the desired output. During the print process, all identified fonts are activated in-process (i.e., during the print process). When a font is activated, either globally or in the local process space, the font module overwrites the previously activated font in memory in the local process space.

According to an aspect of the invention, computer readable media may store computer executable instructions that, when executed, perform a method for ensuring that a document gets printed with appropriately identified fonts. The method includes storing a document for printing, where the document identifies one or more fonts used in the document. The method then stores a job jacket that includes an identification of the document for printing, and further includes an identification of each one or more font files corresponding to the one or more fonts used in the document.

According to another aspect of the invention, computer readable media may store computer executable instructions that, when executed, perform a method for printing a document with the correct fonts. The method includes receiving a print job comprising a document for printing and a job jacket, wherein the job jacket includes an identification of the document for printing, and further includes an identification of a font corresponding to each of one or more fonts used in the document. The method identifies a font file for each font corresponding to the one or more fonts used in the document, and activates each identified font file if not already activated. The method then prints the document based on the one or more identified font files.

Another aspect of the invention provides a data structure for storing a job jacket on one or more computer readable media. The data structure includes a first data field identifying a document to be printed, and one or more second data fields, where each second data field uniquely identifies a font used in the document. Optional third data fields may each store a font file corresponding to a font identified by one of the second data fields.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a data processing system configured to perform one or more illustrative aspects of the invention.

FIG. 2 illustrates a document creation process according to on or more illustrative aspects of the invention.

FIG. 3 illustrates a document printing process according to on or more illustrative aspects of the invention.

FIG. 4 illustrates a job jacket according to on or more illustrative aspects of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

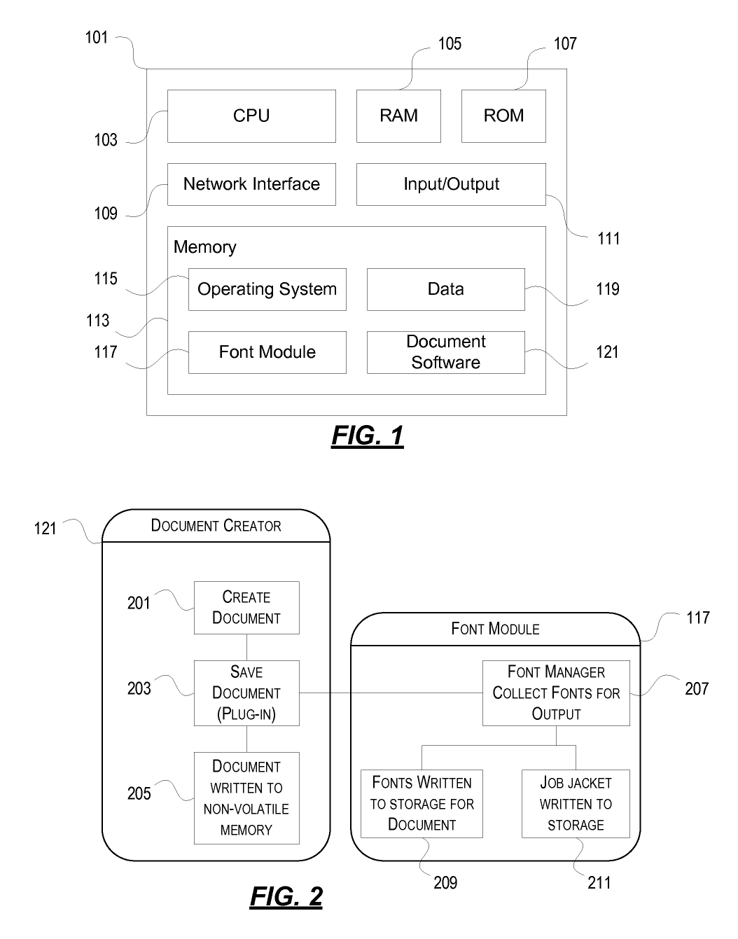

With reference to FIG. 1, the methods and techniques described herein may be implemented as a computer program product 117 or combination of computer program products, for use with a computer system 101. Computer 101 represents a generic computing device, e.g. a desktop computer, laptop computer, notebook computer, network server, portable computing device, personal digital assistant, smart phone, mobile telephone, distributed computing network device, or any other device having the requisite components or abilities to operate as described herein and thereby be configured as a special-purpose device according to one or more illustrative aspects of the invention. Computer 101 may include central processing unit or other processor 103, RAM or other volatile memory 105, ROM or other boot memory 107, network interface(s) 109 (e.g., Ethernet, wireless network interface, modem, etc.) through which computer 101 connects to a network (e.g. Internet, LAN, WAN, PAN, etc.), input/output port(s) 111 (e.g., keyboard, mouse, monitor, printer, USB ports, serial ports, parallel ports, IEEE 1394/Firewire ports, and the like), and non-volatile memory 113 (e.g. fixed disk, optical disk, holographic storage, removable storage media, flash drive, etc.). Computer 101 may store various programs, application, and data in memory 113, including, but not limited to, operating system software 115, font module 117 (e.g., one or more plug-ins and/or other font software), data 119 (e.g., documents, font files, job jackets, and other data described herein), and other document creation application(s) 121 (e.g., ADOBE® brand applications, QUARK® brand applications, etc.). Document creation software may be any software presently known or developed in the future that may be used to create text, graphical, image, photographic, multimedia, or any other type of visually perceptible document.

One or more aspects of the invention may be embodied in computer-usable data and/or computer-executable instructions, such as in one or more program modules, executed by one or more computers or other devices to render one or more fonts for output on a device such as a display or a printer. Generally, program modules include routines, programs, objects, components, data structures, etc. that perform particular tasks or implement particular abstract data types when executed by a processor in a computer or other data processing device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

FIG. 2 illustrates a Document Preparation process, whereby when a document is finished and ready for printing (but not actually yet being printed), a creative professional may use a plug-in user interface according to various aspects of the invention to collect and store the fonts necessary to print the document. A creative professional may be a graphic artist, typesetter, copywriter, professional printer, or any other person involved with creation, editing, and/or printing of a document. Initially, in step 201, the creative professional creates a document using document creator software 121, e.g., Adobe®, Quark®, or other document creation software. When the creative professional indicates a desire to save the document in step 203, two sub-processes are initiated: one by the document creator 201, and a second by the font module 117. Document creator software 121 may spawn, call, or otherwise initiate the sub-process performed by font module 117. In step 205, document creation software 121 writes the document to storage, e.g., any non-volatile memory. According to an aspect of the invention, the document may be written to a portable memory, for example a USB flash drive.

The font module sub-process (steps 207-211) generally involves the font module (e.g., plug-in) collecting and storing the necessary fonts into the same memory medium as the document, together with a job jacket which, according to one aspect of the invention, may be an XML file as further described below. Thus, in step 207, font module 117 collects identifying information for all fonts used to create the document. Step 207 may include the font module assembling a linked list of all font IDs used in the document, storing the font names and/or filenames in a database, or any other identification and storage technique. In step 209 the font module 117 stores copies of the identified fonts to non-volatile memory, preferably in the same location as the document. In step 211 the font module 117 prepares a job jacket for storage with the document. The job jacket contains references to the fonts necessary to reproduce the document, as well as a reference to the document itself.

According to an aspect of the invention, the job jacket may comprise an XML file having the same name as the original document, but with a different file extension, e.g., XML, JKT, etc. An illustrative job jacket is illustrated in FIG. 4. The reference to the document may comprise the name of the job jacket file, and/or the reference to the document may be included within the job jacket file. The reference to one or more fonts may include a filename, a file location, and/or any identifier for a specific font. According to an illustrative aspect of the invention, a unique font identification system may be used, e.g., Font Sense, a font identification and matching technology available for purchase by the public from Extensis, Inc. in Portland, Oreg., which provides a unique font identifier for any given font. Where the reference to the font(s) includes a file location, the paths to the fonts may be relative to the location of the job jacket in order to maintain portability of the job jacket. i.e., a fixed path including a drive letter is not portable. The job jacket thus provides portability across computers and even across operating systems. The job jacket may comprise any document format desired, and is not limited to an XML or even specifically a markup language document, but rather may be any format provided the requisite information is included therein.

The job jacket along with the referenced document and font(s) constitute a print job, which may be provided to a pre-press operator for printing. The print job may be provided on portable media, e.g., USB flash drive, optical disk, or the like, and/or may be transmitted via one or more networks, e.g., over the Internet. The print job may further be encapsulated in a file encapsulation and/or compression format, e.g., .ZIP, .TAR, etc. According to an illustrative aspect of the invention, the creative professional can also provide the font module/plug-in as a fourth element of the print job.

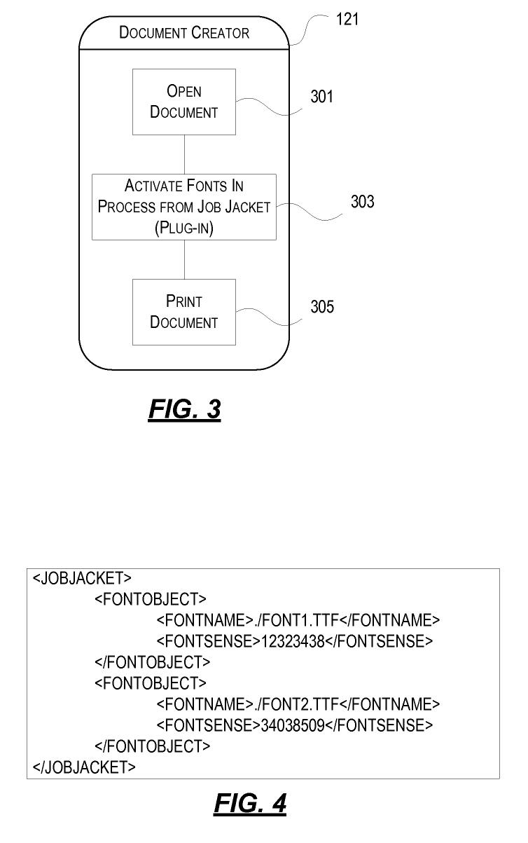

FIG. 3 illustrates a Document Printing process. After receiving the print job, the creative professional opens the document in step 301 using document creator software 121 (or other software capable of reading the file format of the document). When the user (creative professional) indicates a desire to print the document, a message is sent to the font module 117 by the document creation application 121. Alternatively, the message may be sent automatically when the document is opened. The font module may scan the computer's memory for the job jacket, e.g., based on the name of the document to be printed, the Font Sense ID, or other identifying information provided in the job jacket. Where a relative file location is not provided for each font, the font module 117 may an operating system search mechanism to locate the desired fonts. Where a Font Sense ID (or other ID) is provided for each font, the font module 117 may search the computer system for the applicable ID(s), e.g., using the operating system's built in search abilities. After locating the identified fonts, Font module 117, in step 303, activates the fonts in-process, without the need to communicate the activations of the font(s) to the font manager for the host computer system. Using the now active fonts, the document software 121 and/or the font module 117 print the document in step 305.

According to an aspect of the invention, a search plug-in may be used to expedite searching an operating system or file storage for a particular font ID, e.g., a Font Sense ID. A search plug-in may be provided for the Spotlight™ search tool provided with Apple's Mac OS X, whereby Spotlight™ indexes the ID along with other relevant metadata (such as font name, author, etc.) of any font file stored on the computer and stores the information in Spotlight's™ underlying SQLite database for fast query and retrieval at a later time. Plug-ins for other search tools may also and/or alternatively be provided, e.g., Microsoft® Windows® Instant Search™ in its Vista® operating system, Google search, MSN search, or the like.

According to another alternative embodiment, the job jacket and/or Font Sense ID (or other font ID) of each font used in a document may be embedded within the document itself, e.g., as a slug in a QUARK® document file. In such a scenario, the print job might include only the document, or only the document and the font files. The receiving font module then searches the computer's storage for the applicable font ID(s) if necessary, and activates the font(s) in-process as described herein.

Various examples of the invention may thus provide a number of benefits to a pre-press operator. For example, a pre-press operation may avoid having to worry about other fonts being active, because no other fonts can interfere with the job printing. Further, printing can be completely automated, even when the document to be printed contains fonts with the same Postscript names as system fonts necessary to run the operating system. Still further, the use of the in-process activated fonts will not interfere with other fonts having the same postscript name concurrently being used by other processes that have been globally activated, such as system fonts.

Font activation may vary among operating systems. An illustrative contrast is between APPLE's MAC OS brand operating systems and MICROSOFT's WINDOWS® brand operating systems. For example, the font activation model in OS X is stack based, whereas in WINDOWS it typically is not. In OS X the font activation process can choose between local and global activation. Thus when you activate a font in-process in OS X the font will override the system font, but just for that process in which the font was activated (assuming local activation was selected).

By contrast, in the WINDOWS operating systems all font activations are global, even when called by a specific process. In-process font activation in WINDOWS operating systems work insofar as the desired end-result is achieved; however, the in-process activation is global. Thus, in OS X and similar operating systems the font activation would be locally in-process, whereas in WINDOWS and similar operating systems the font activation is global. Because font activation is always global in WINDOWS operating systems, if the font module overwrites a system font during in-process activation, the font module preferably reactivates the overwritten system font when the in-process font is deactivated at the end of the process. Activating globally in process may provide benefits where multiple desktop publishing applications use elements of the same print job. For example, a document may be embedded in another document as an object, and/or two desktop publishing applications might be operating in separate process spaces and might both need to have the fonts activated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer readable media storing computer executable instructions that, when executed, perform a method, comprising:
storing a document for printing, said document identifying one or more fonts used in the document;
storing a job jacket comprising an identification of the document for printing, and further comprising an identification of each of one or more font files corresponding to the one or more fonts used in the document.

2. The computer readable media of claim 1, wherein the identification of the document for printing comprises a filename of the stored document having a different file extension.

3. The computer readable media of claim 1, wherein the identification of the document for printing comprises a data field stored in job jacket.

4. The computer readable media of claim 1, wherein the identification of each font file comprises a relative file location and file name for each font file.

5. The computer readable media of claim 1, wherein the identification of each font file comprises a unique font identifier.

6. The computer readable media of claim 1, wherein said method further comprises:
packaging the document and the job jacket as a print job; and
transmitting the print job to a third party for printing of the document based on the one or more fonts.

7. The computer readable media of claim 1, wherein the print job further comprises copies of the one or more font files.

8. The computer readable media of claim 1, wherein the job jacket is embeddedly stored within the document.

9. One or more computer readable media storing computer executable instructions that, when executed, perform a method, comprising:
receiving a print job comprising a document for printing and a job jacket, wherein said job jacket includes an identification of the document for printing, and further includes an identification of a font corresponding to each of one or more fonts used in the document;
identifying a font file for each font corresponding to the one or more fonts used in the document;
activating each identified font file if not already activated; and
printing the document based on the one or more identified font files.

10. The computer readable media of claim 9, wherein the identification of the document comprises a filename of the document having a different file extension.

11. The computer readable media of claim 9, wherein the identification of the document comprises a data field stored in the job jacket.

12. The computer readable media of claim 9, wherein the identification of each font file comprises a relative file location and file name for each font file.

13. The computer readable media of claim 9, wherein the print job further comprises copies of the one or more font files.

14. The computer readable media of claim 9, wherein the identification of each font file comprises a unique font identifier.

15. The computer readable media of claim 14, wherein identifying a font file for each font corresponding to the one or more fonts used in the document comprises searching one or more storage devices for and identifying a font file corresponding to each unique font identifier.

16. The computer readable media of claim 9, wherein activating comprises local activation of the font file.

17. The computer readable media of claim 9, wherein activating comprises global activation of the font file.

18. The computer readable media of claim 9, wherein the job jacket is embedded within the document for printing.

19. One or more computer readable media storing a data structure thereon, said data structure usable to ensure that a document is printed with correctly identified font files, wherein said data structure comprises:
a first data field identifying a document to be printed; and
one or more second data fields, each second data field uniquely identifying a font used in the document.

20. The computer readable media of claim 19, wherein said first data field comprises a filename of the stored document having a different file extension.

21. The computer readable media of claim 19, wherein each second data field comprises a relative file location and file name corresponding to a font file.

22. The computer readable media of claim 19, wherein each second data field comprises a unique font identifier.

23. The computer readable media of claim 19, wherein said data structure further comprises one or more third data fields, each said third data field storing a font file corresponding to a font identified by one of the second data fields.
